(19) United States
(12) Patent Application Publication
(10) Pub. No.: US 2022/0246096 A1
(43) Pub. Date: Aug. 4, 2022

(54) TECHNIQUE FOR UNDER-DISPLAY SENSOR ILLUMINATION

(71) Applicant: Google LLC, Mountain View, CA (US)

(72) Inventors: Sangmoo Choi, Palo Alto, CA (US); Yi Zhang, Sunnyvale, CA (US)

(21) Appl. No.: 17/275,281

(22) PCT Filed: Oct. 21, 2020
(86) PCT No.: PCT/US2020/056667

§ 371 Date: Mar. 11, 2021

Related U.S. Application Data
(60) Provisional application No. 62/924,244, filed on Oct. 22, 2019.

(51) Int. Cl. G09G 3/3233

(52) U.S. Cl. CPC G09G 3/3233; G09G 2310/08; G09G 2300/0842; G09G 2300/0819

(57) ABSTRACT

Methods, systems, and apparatus, including computer programs encoded on computer storage media, for driving a display including groups of light-emitting pixels. A sensor is arranged under the display. The sensor includes an emitter for directing electromagnetic radiation through multiple pixels of the display located over the emitter. The method includes addressing each group of pixels in the plurality of groups of light-emitting pixels with signals according to a frame rate wherein a period of each frame during which the groups of light-emitting pixels are addressed includes an emission-off period during which none of the multiple pixels located over the emitter emit light; and synchronizing emission of electromagnetic radiation from the emitter through the multiple pixels located over the emitter to occur only during the emission-off period of the multiple pixels located over the emitter.

### CROSS-REFERENCE TO RELATED APPLICATION

This application claims the benefit of U.S. Application No. 62/924,244, filed Oct. 22, 2019, which is incorporated by reference in its entirety.

### TECHNICAL FIELD

This specification relates generally to flat panel displays and reducing visual artifacts in flat panel displays.

### BACKGROUND

Electronic devices may include flat panel displays on which visual images may be shown. For example, a user of a computing device may view visual images on a flat panel display while watching a video or playing a video game.

### SUMMARY

In flat panel display systems, such as OLED display panels, when electromagnetic sensors are located under a display panel, the image on the display can show unwanted visual artifacts associated with electromagnetic emission from the sensor. The unwanted visual artifacts are often observed as white, or glowing, dots. The visual artifacts typically occur because of the interaction between electromagnetic radiation passing through the display panel and the integrated circuits controlling emission from pixels near to the sensor.

Sensors may be located under a display panel in order to increase the screen-to-body ratio of electronic devices. Specifically, by placing the sensor under the display, the width of the bezel can be reduced, as it no longer needs to accommodate the sensor. In addition, the use of an unsightly notch or aperture in the display can be avoided.

The sensors may include emitters of electromagnetic energy, e.g., infrared (IR), radio, and ultraviolet (UV) energy. The emitters can emit the electromagnetic energy as a pulse or sequence of pulses, e.g., an IR pulse or pulses. The sensors may direct the electromagnetic energy through a pixel array of the display panel. Electromagnetic energy passing through the pixel array of the display panel is likely to interfere with pixel circuits of the display panel, resulting in visual artifacts.

A process of driving a display while reducing (e.g., minimizing) visual artifacts due to electromagnetic radiation can include synchronizing IR pulses from the sensor with certain electrical drive signals used to control emission of light from the display pixels, e.g., emission (EM) and scan signals. The process can include synchronizing the electromagnetic sensors to emit IR pulses during time periods when pixels are not emitting light, and to cease or prevent IR emission during time periods when pixels are emitting light. For example, the process can include synchronizing the electromagnetic sensors to emit IR pulses before scanning image data to the pixels.

The process for reducing visual artifacts due to electromagnetic radiation can be used in a display that has one or more scan pulses per image frame. The display can be driven such that the electromagnetic sensor emits an IR pulse or pulses during an EM signal pulse (i.e. during an emission-off period), and before a final scan pulse for an image frame.

The process for reducing visual artifacts due to electromagnetic radiation can also be used in a display that has one or more EM signal pulse per image frame. A scan pulse, or scan period, may occur during only one EM signal pulse of the one or more EM signal pulses. For example, the scan pulse may occur during only the first EM signal pulse of the one or more EM signal pulses. The display can be driven such that the electromagnetic sensor emits an IR pulse before the scan pulse, and during the EM signal pulse during which the scan pulse occurs.

The process for reducing visual artifacts due to electromagnetic radiation can be applied to one or more groups of pixels. For example, the process can be applied to one or more rows or columns of a pixel array. In some examples, a display system can synchronize IR pulses with EM signals and scan signals for only the pixel rows or columns that are adjacent to, e.g., located over, the emitter.

In general, one innovative aspect of the subject matter described in this specification can be embodied in a method of driving a display including a plurality of groups of light-emitting pixels and a sensor arranged under the display. The sensor includes an emitter arranged to direct electromagnetic radiation through multiple pixels of the display located over the emitter during operation. The method includes addressing each group of pixels in the plurality of groups of light-emitting pixels with one or more signals according to a frame rate. A period of each frame during which the groups of light-emitting pixels are addressed includes an emission-off period during which none of the multiple pixels located over the emitter emit light. The method includes synchronizing emission of electromagnetic radiation from the emitter through the multiple pixels located over the emitter to occur during the emission-off period of the multiple pixels located over the display.

In some implementations, said synchronizing emission of electromagnetic radiation from the emitter through the multiple pixels located over the emitter to occur during the emission-off period of the multiple pixels located over the emitter may comprise synchronizing emission of electromagnetic radiation from the emitter to occur during a respective emission-off period of one or more groups of pixels each containing one or more pixels located over the emitter.

In some implementations, the period of each frame includes a scan period during which the pixels in each group of pixels receive a data signal. The method further includes synchronizing emission of electromagnetic radiation from the emitter through the multiple pixels of the display located over the emitter to occur before the scan period. The scan period may be during the emission-off period.

In some implementations, the period of each frame includes a plurality of emission-off periods and a scan period during which the pixels in each group of pixels receive a data signal. The scan period occurs during one of the plurality of emission-off periods. The method further includes synchronizing emission of electromagnetic radiation from the emitter through the multiple pixels of the display located over the emitter to occur during the one period of the plurality of emission-off periods during which the scan period occurs.

In some implementations, the emission of electromagnetic radiation from the emitter through the multiple pixels of the display located over the emitter may be synchronized to occur during the one period of the plurality of emission-off periods during which the scan period occurs, and before the scan period.

In some implementations, the period of each frame includes an emission-off period; a plurality of scan periods occurring during the emission-off period, the plurality of scan periods including at least one scan period during which the multiple pixels located over the emitter receive a precharging voltage; and a scan period during which the multiple pixels located over the emitter receive a data signal; the method further including synchronizing emission of electromagnetic radiation from the emitter through the multiple pixels of the display located over the emitter to occur (i) during the emission-off period and (ii) before the scan period during which the multiple pixels located over the emitter receive the data signal.

In some implementations, where a plurality of emission-off periods are provided, and a plurality of scan periods are provided, the plurality of scan periods may be synchronized to occur during one of the plurality of emission-off periods, and emission of electromagnetic radiation from the emitter may be synchronized to occur during said one of the plurality of emission-off periods.

In some implementations, the scan period during which the multiple pixels located over the emitter receive the data signal is a final scan period of the plurality of scan periods.

In some implementations, the emission-off period occurs prior to programming an illumination level for each pixel in the corresponding frame.

In some implementations, the programming an illumination level for each pixel in the corresponding frame may occur during a scan period.

In some implementations, each group of pixels includes a row of pixels or a column of pixels.

In some implementations, the method includes repeatedly addressing the group of pixels during emission-off periods of additional frames.

In some implementations, the method includes repeatedly synchronizing emission of electromagnetic radiation from the emitter through the multiple pixels of the display located over the emitter to occur during emission-off periods of additional frames.

In some implementations, synchronizing the emission of electromagnetic radiation from the emitter through the multiple pixels located over the emitter to occur during the emission-off period includes: starting the emission of electromagnetic radiation from the emitter at or after the start of the emission-off period; and stopping the emission of electromagnetic radiation from the emitter at or before the end of the emission-off period.

In some implementations, synchronizing the emission of electromagnetic radiation from the emitter through the multiple pixels located over the emitter to occur before the scan period may comprise starting the emission of electromagnetic radiation from the emitter before the start of the scan period, and stopping the emission of electromagnetic radiation from the emitter at or before the start of the scan period.

In some implementations, the electromagnetic radiation is one of infrared radiation, ultraviolet radiation, or radio wave radiation.

In some implementations, each light-emitting pixel of the groups of light-emitting pixels in the plurality of groups of light-emitting pixels includes an organic light-emitting diode.

Implementations of the above techniques include methods, apparatus, systems, and computer program products. One such computer program product is suitably embodied in a non-transitory machine-readable medium that stores instructions executable by one or more processors. The instructions are configured to cause the one or more processors to perform the above-described actions.

One further implementation is a system comprising a display comprising a plurality of groups of light-emitting pixels, a sensor arranged under the display, the sensor comprising an emitter arranged to direct electromagnetic radiation through multiple pixels of the display located over the emitter during operation, and a controller configured to perform operations. The operations comprise addressing each group of pixels in the plurality of groups of light-emitting pixels with one or more signals according to a frame rate, wherein a period of each frame during which the groups of light-emitting pixels are addressed comprises an emission-off period during which none of the multiple pixels located over the emitter emit light, and synchronizing emission of electromagnetic radiation from the emitter through the multiple pixels located over the emitter to occur during the emission-off period of the multiple pixels located over the emitter.

In some implementations, the period of each frame comprises a scan period during which the pixels in each group of pixels receive a data signal. The operations may further comprise synchronizing emission of electromagnetic radiation from the emitter through the multiple pixels of the display located over the emitter to occur before the scan period.

In some implementations, the period of each frame comprises a plurality of emission-off periods, and a scan period during which the pixels in each group of pixels receive a data signal. The scan period may occur during one of the plurality of emission-off periods. The operations may further comprise synchronizing emission of electromagnetic radiation from the emitter through the multiple pixels of the display located over the emitter to occur during the one period of the plurality of emission-off periods during which the scan period occurs.

In some implementations, the emission of electromagnetic radiation from the emitter through the multiple pixels of the display located over the emitter may be synchronized to occur during the one period of the plurality of emission-off periods during which the scan period occurs, and before the scan period.

In some implementations, the period of each frame comprises a plurality of scan periods occurring during the emission-off period. The plurality of scan periods may comprise at least one scan period during which the multiple pixels located over the emitter receive a precharging voltage, and a scan period during which the multiple pixels located over the emitter receive a data signal. The operations may further comprise synchronizing emission of electromagnetic radiation from the emitter through the multiple pixels of the display located over the emitter to occur (i) during the emission-off period and (ii) before the scan period during which the multiple pixels located over the emitter receive the data signal.

In some implementations, where a plurality of emission-off periods are provided, and a plurality of scan periods are provided, the plurality of scan periods may be synchronized to occur during one of the plurality of emission-off periods, and emission of electromagnetic radiation from the emitter may be synchronized to occur during said one of the plurality of emission-off periods.

In some implementations, the scan period during which the multiple pixels located over the emitter receive the data signal comprises a final scan period of the plurality of scan periods.

In some implementations, the emission-off period occurs prior to programming an illumination level for each pixel in the corresponding frame.

In some implementations, each group of pixels comprises a row of pixels or a column of pixels.

In some implementations, the operations include repeatedly synchronizing emission of electromagnetic radiation from the emitter through the multiple pixels of the display located over the emitter to occur during emission-off periods of additional frames.

In some implementations, synchronizing the emission of electromagnetic radiation from the emitter through the multiple pixels located over the emitter to occur during the emission-off period comprises starting the emission of electromagnetic radiation from the emitter at or after the start of the emission-off period, and stopping the emission of electromagnetic radiation from the emitter at or before the end of the emission-off period.

In some implementations, the electromagnetic radiation may be one of infrared radiation, ultraviolet radiation, or radio wave radiation.

In some implementations, each light emitting pixel of the groups of light-emitting pixels in the plurality of groups of light-emitting pixels may comprise an organic light-emitting diode.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B are diagrams of an example electronic device with a display panel and an electromagnetic sensor.

FIG. 2 is a diagram of a display system of an electronic device.

FIG. 3 is a diagram of an example pixel circuit of a display system.

FIGS. 4A and 4B are example operating timing diagrams for displays that use one scan pulse per frame.

FIGS. 5A and 5B are example operating timing diagrams for displays that use more than one scan pulse per frame.

FIG. 6 is an example operating timing diagram for displays that use more than one EM signal pulse per frame.

Like reference numbers and designations in the various drawings indicate like elements.

### DETAILED DESCRIPTION

An example flat panel display that may experience visual artifacts due to electromagnetic interference from an under-display sensor is an organic light-emitting diode (OLED) display. An OLED display generally includes an array of pixels, each pixel including one or more OLEDs. An OLED display is typically driven by driver circuits including a row driver and a column driver. The row driver, e.g., a scan driver, typically sequentially selects each row of pixels in the display, and the column driver, e.g., a data driver, provides data voltage to pixel circuits in the selected row. The pixel circuits generate electric current that corresponds to the data voltage, and provide the current to OLEDs of the pixel, enabling the selected OLEDs to emit light, and presenting an image on the display. Signal lines such as horizontal scan lines and vertical data lines may be used in controlling the pixels to display images on the display.

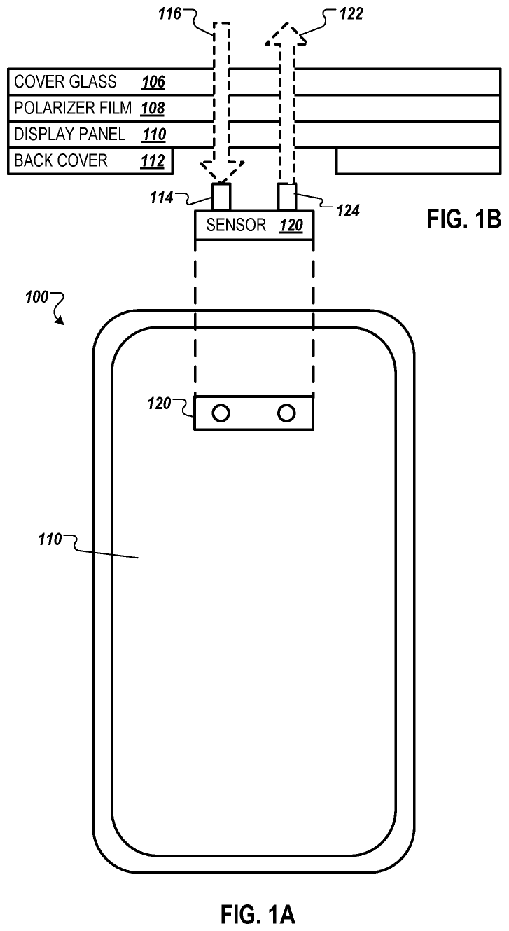

FIGS. 1A and 1B are diagrams of an example electronic device 100 with a display panel 110 and an electromagnetic sensor 120. FIG. 1A illustrates a front perspective view of the electronic device 100. FIG. 1B illustrates an example cross section view of the electronic device 100.

Referring to FIG. 1A, the electronic device 100 may be, for example, a smart phone, a television, a smart watch, or a handheld game console. The display panel 110 includes an array of light emitting pixels. In operation, the display panel 110 can display an image by illuminating the light emitting pixels. The display panel 110 may be, for example, an active matrix organic light emitting diode (OLED) panel, or a light emitting diode (LED) liquid crystal displays (LCD) panel. The electronic device 100 includes an electromagnetic sensor 120 adjacent to the display panel 110. For example, the electromagnetic sensor 120 may be located under the display panel, e.g., behind the display panel 110 from the front perspective view of the electronic device 100.

Referring to FIG. 1B, a top layer of the cross section of the electronic device 100 includes a cover glass 106. A polarizer film 108 is located under the cover glass 106. The display panel 110, including an array of light emitting pixels, is located under the polarizer film 108.

The electromagnetic sensor 120 is located under the display panel 110. For example, the electromagnetic sensor 120 may be located under the display panel 110, from the cross section view of the electronic device 100. The pixels of the display panel 110 are thus positioned over the electromagnetic sensor 120. In some examples, the electromagnetic sensor 120 can be connected to a motherboard of the electronic device 100. In some examples, the electromagnetic sensor 120 can be connected to a back cover 112 of the electronic device 100.

The electromagnetic sensor 120 can include an emitter 124 and a receiver 114. In operation, the emitter 124 can direct electromagnetic radiation, e.g., in the form of a transmitted pulse 122, through the pixel array of the display panel 110. The receiver can receive a returning pulse 116 of electromagnetic energy through the display panel 110.

The electromagnetic sensor 120 can be, for example, an infrared (IR) sensor that emits and receives electromagnetic energy in the IR band of the electromagnetic spectrum. In some examples, the electromagnetic sensor 120 can be a near IR sensor or a short-wavelength IR sensor. In some examples, the electromagnetic sensor 120 can be a UV sensor, a LIDAR sensor, or a RADAR sensor. In some examples, the electromagnetic sensor 120 can emit and receive electromagnetic energy in a range of bands of the electromagnetic spectrum. In some examples, the electronic device 100 can include more than one electromagnetic sensor 120.

The electromagnetic sensor 120 can be used, for example, to remotely and wirelessly control a device such as a television, cable box, or sound system. In some examples, the electromagnetic sensor 120 can be used for IR illumination. When used for IR illumination, the electromagnetic sensor 120 can project IR radiation to an area, and receive the IR radiation reflected off objects in the area. In some examples, the electromagnetic sensor 120 can emit and receive IR radiation in conjunction with a visible light camera to capture images of an area in dark lighting.

When the electromagnetic sensor 120 emits electromagnetic radiation, e.g., an IR pulse, the emitter 114 can interfere with circuits within the pixel array of the display panel 110. IR interference can cause visual display artifacts to appear on the display panel 110. For example, IR interference may cause pixel glowing, resulting in a dot appearing on the display panel 110 above the electromagnetic sensor 120. The dot can often appear as a white dot.

The size, shape, and intensity of the white dot may depend on characteristics of the electromagnetic sensor 120. For example, a larger sized emitter 124 may cause a larger sized white dot to appear. In some examples, a smaller wavelength of electromagnetic radiation may cause additional interference and result in a larger or brighter white dot appearing on the display panel 110. The electromagnetic sensor 120 may have varying effects on pixels within the pixel array. For example, pixels located in close proximity to the location of the electromagnetic sensor may experience greater interference than pixels that are further from the electromagnetic sensor 120. In some examples, an emitter 124 with a wider field of view may cause larger white dots to appear on the display panel.

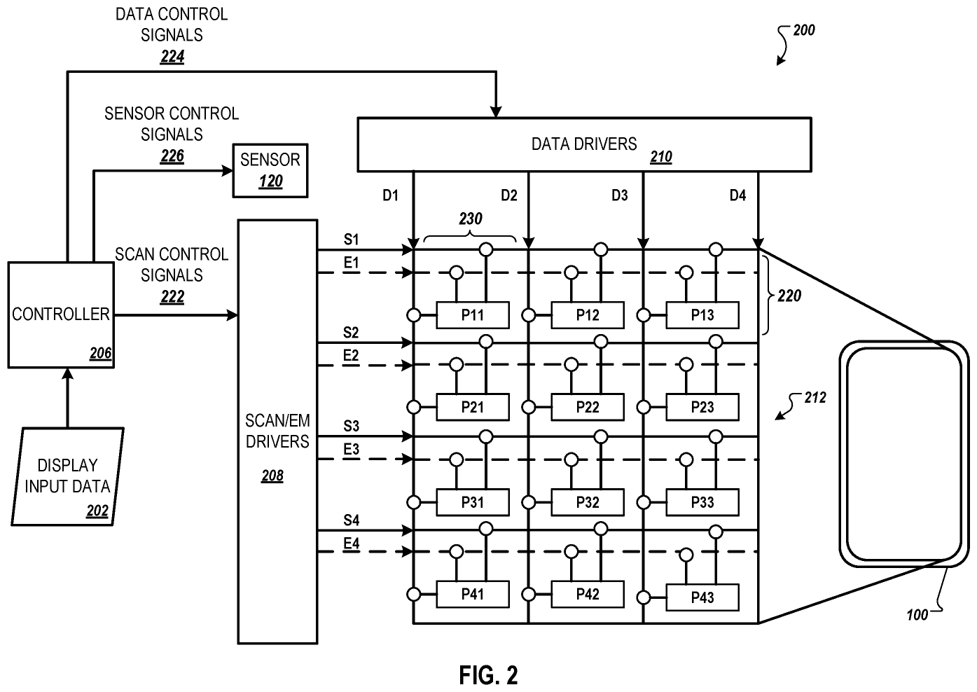

FIG. 2 is a diagram of an example display system 200 of an electronic device. For example, FIG. 2 may illustrate the display system 200 of the electronic device 100. The display system 200 is an OLED display system that includes an array 212 of light emitting pixels. Each light emitting pixel includes an OLED. The OLED display is driven by drivers including SCAN/EM drivers 208 and data drivers 210. The SCAN/EM drivers 208 can be integrated, i.e., stacked, row line drivers. In general, the SCAN/EM drivers 208 selects a row of pixels in the display, and the data drivers 210 provide data signals (e.g. voltage data) to the pixels in the selected row to light the selected OLEDs according to image data. Signal lines such as scan lines, EM lines, and data lines may be used in controlling the pixels to display images on the display. Though FIG. 2 illustrates the display system 200 having the SCAN/EM drivers 208 on one side, the SCAN/EM drivers 208 can be placed on both left and right sides of the display improving the driving performance (e.g. speed).

The display system 200 includes the pixel array 212 that includes a plurality of light emitting pixels, e.g., the pixels P11 through P43. A pixel is a small element on a display that can change color based on the image data supplied to the pixel. Each pixel within the pixel array 212 can be addressed separately to produce various intensities of color. The pixel array 212 extends in a plane and includes rows and columns.

Each row extends horizontally across the pixel array 212. For example, the first row 220 of the pixel array 212 includes pixels P11, P12, and P13. Each column extends vertically down the pixel array 212. For example, the first column 230 of the pixel array 212 includes pixels P11, P21, P31, and P41. Only a few pixels are shown in FIG. 2 for simplicity. In practice, there may be several million pixels in the pixel array 212. Greater numbers of pixels can result in higher image resolution.

The display system 200 includes SCAN/EM drivers 208 and data drivers 210. The SCAN/EM drivers supply SCAN and EM signals to rows of the pixel array 212. For example, the SCAN/EM drivers 208 supply scan signals via scan lines S1 to S4, and EM signals via EM lines E1 to E4, to the rows of pixels. The data drivers 210 supply signals to columns of the pixel array 212. For example, the data drivers 210 supply data signals, via data lines D1 to D4, to the columns of pixels.

Each pixel in the pixel array 212 is addressable by a horizontal scan line and EM line, and a vertical data line. For example, the pixel P11 is addressable by the scan line S1, the EM line E1, and the data line D1. In another example, the pixel P32 is addressable by the scan line S3, the EM line E3, and the data line D2.

The SCAN/EM drivers 208 and the data drivers 210 provide signals to the pixels enabling the pixels to reproduce the image on the display. The SCAN/EM drivers 208 and the data drivers 210 provide the signals to the pixels via the scan lines, the emission lines, and the data lines. To provide the signals to the pixels, the SCAN/EM drivers 208 select a scan line and control the emission operation of the pixels. The data drivers 210 provides data signals to the pixels addressable by the selected scan line to light the selected OLEDs according to the image data.

The scan lines are addressed sequentially for each frame. A frame is a single image in a sequence of images that are displayed. A scan direction determines the order in which the scan lines are addressed. In the display system 200, the scan direction is from top to bottom of the pixel array 212. For example, the scan line S1 is addressed first, followed by the scan lines S2, then S3, etc.

The display system 200 includes a controller 206 that receives display input data 202. The controller 206 generates scan control signals 222 and data control signals 224 from the display input data 202. The scan control signals 222 are used to drive the SCAN/EM drivers 208. The data control signals 224 are used to drive the data drivers 210. The controller 206 controls the timing of the scan signals and EM signals through the scan control signals 222. The controller 206 controls the timing of the data signals through the data control signals 224.

The controller 206 can also control the timing of the sensor 120. The controller 206 can control the timing of the sensor 210 through sensor control signals 226. The sensor control signals 226 can include start and stop signals. The controller 206 can send a start signal to the sensor 120 to allow the sensor 120 to emit electromagnetic radiation, e.g., an IR pulse. The controller 206 can send a stop signal to the sensor 120 to cause the sensor 120 to cease emitting electromagnetic radiation, or to prevent the sensor 120 from emitting electromagnetic radiation.

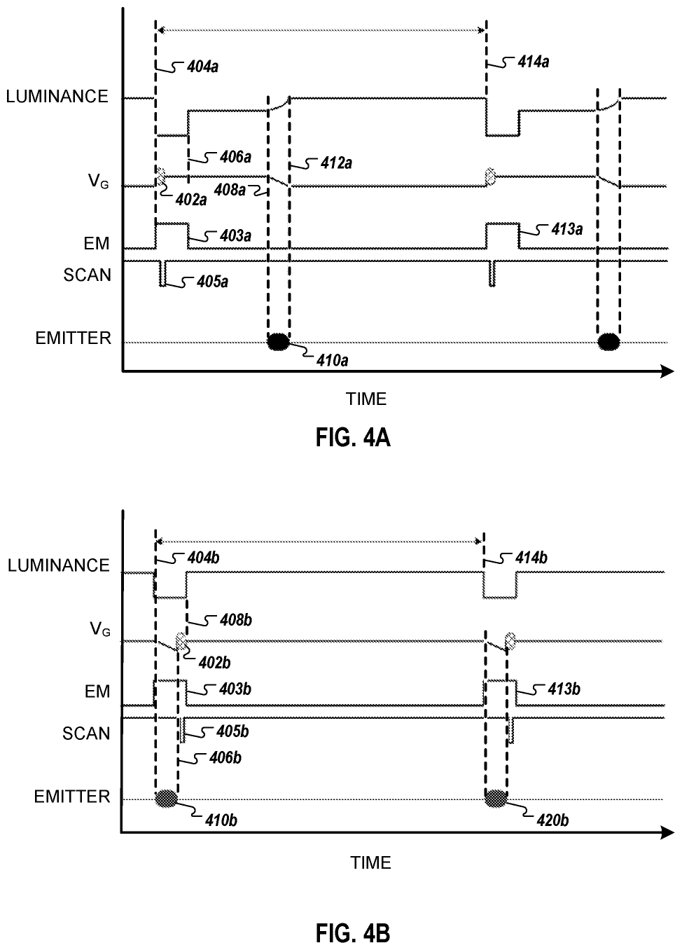

The controller 206 can synchronize the scan control signals 222, data control signals 224, and sensor control signals 226 to reduce interference between the sensor 120 emissions and pixel light emissions. For example, the controller 206 can synchronize the sensor control signals 226 with the scan control signals 222 to prevent the sensor 120 from emitting electromagnetic energy during an EM signal pulse for groups of pixels, e.g., pixel rows, located near to the sensor 120. The controller 206 can also synchronize the sensor control signals 226 with the scan control signals 222 to prevent the sensor 120 from emitting electromagnetic radiation during a scan period for pixel rows located near to the sensor 120. Synchronization between EM signals, scan signals, and data signals is described in additional detail in reference to FIGS. 4, 5, and 6.

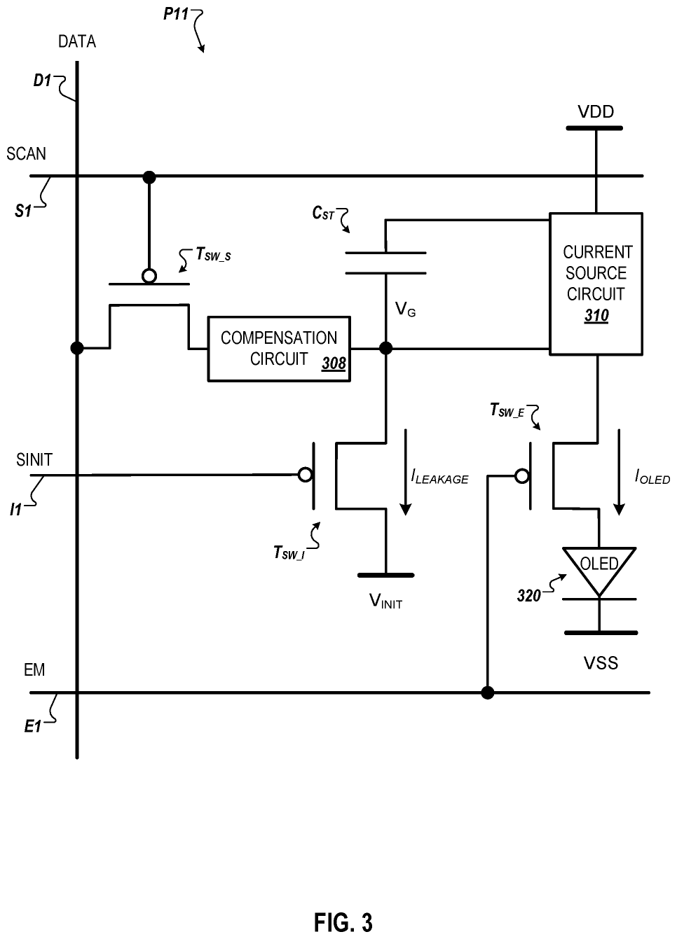

FIG. 3 is a diagram of an example pixel circuit of a display system. For example, FIG. 3 may illustrate a more detailed view of the pixel P11 of the display system 200. The pixel P11 is an active matrix OLED (AMOLED) pixel. The pixel P11 is addressable by horizontal scan line S1, emission line E1, vertical data line D1, and initializing signal line I1. The pixel P11 receives a scan signal “SCAN” from the scan line S1, a data voltage “DATA” from the data line D1, and an emission signal “EM” from the emission line E1. The pixel P11 also receives an initializing signal “SINIT” from an initial signal line I1. The pixel P11 receives power supply voltage VDD and an initial reference voltage V_{InIT}. The pixel P11 is connected to a common ground VSS.

The pixel P11 includes an organic light-emitting diode (OLED) 320. The OLED 320 includes a layer of an organic compound that emits light in response to an electric current, I_{OLED}. The organic layer is positioned between two electrodes: an anode and a cathode. The OLED 320 is driven by a current source circuit 310, which receives the supply voltage VDD. The current source circuit 310 drives the OLED 320 to emit light.

The pixel P11 includes a storage capacitor C_{ST}. The purpose of the storage capacitor C_{ST} is to maintain the gate voltage V_{G} during illumination of the pixel P11.

The pixel P11 also includes multiple p-channel switching thin film transistors (TFTs). The switching TFTs include a signal TFT (T_{SW_S}), an initializing TFT (T_{SW_1}), and an emission TFT (T_{SW_E}).

During operation, the switching TFT T_{SW_S} starts and stops the charging of the storage capacitor C_{ST} based on receiving the SCAN signal from the scan line S1. During an addressing period, the scan line S1 turns on the switching TFT T_{SW_S}. The switching TFT T_{SW_S} provides the data voltage DATA from the data line D1 to the storage capacitor C_{ST} and to the current source circuit 310. The compensation circuit 308 can compensate for transistor variations in the pixel P11.

The pixel P11 is programmed by the control signals: SCAN, SINIT, EM, and DATA. The OLED current, I_{OLED}, varies by the gate voltage V_{G}. When the gate voltage V_{G} is steady, the pixel maintains a steady luminance throughout a frame time, displaying light corresponding to the supplied image data as programmed. A frame time, or frame period, is the amount of time between a start of a frame and a start of a next frame. The frame time can be the inverse of a frame rate of a display system. For example, a frame rate of 60 frames per second (fps) corresponds to a frame time of 1/60 seconds, or 0.0167 seconds.

When the current source circuit 310 receives the data voltage DATA through the switching TFT T_{SW_S}, the current source circuit 310 provides a specified current I_{OLED} to the OLED 320 based on the received data voltage DATA, such that the OLED 320 emits light in accordance with the electric current I_{OLED}. The intensity or brightness of the light depends on the amount of electrical current I_{OLED} applied. A higher current can result in brighter light. Thus, the intensity of the light emitted from the OLED 320 is based on the data voltage DATA that corresponds to image data for the individual pixel. The storage capacitor C_{ST} maintains the pixel state such that the pixel P11 remains illuminated continuously after the addressing period. Exposure to electromagnetic radiation may cause a leakage current I_{leakage} to flow from the storage capacitor C_{ST} through the TFT T_{SW_1}. The leakage current I_{leakage} can affect the OLED current I_{OLED}, causing changes to the illumination level of the pixel P11.

Although FIG. 2 and FIG. 3 illustrate example components of an OLED display, the described techniques may be applied to any flat panel display that includes an array of pixels. For example, the process for reducing artifacts due to electromagnetic radiation may be applied to light emitting diode (LED) liquid crystal displays (LCD) and plasma display panels (PDP).

FIGS. 4A and 4B are example operating timing diagrams for displays that use one scan pulse per frame. FIG. 4A illustrates an example timing diagram for a display system with an electromagnetic sensor that is not synchronized with the EM signal and the SCAN signal of the OLED. FIG. 4B illustrates an example timing diagram for a display system with an electromagnetic sensor that is synchronized with the EM signal and the SCAN signal of the OLED.

FIGS. 4A and 4B illustrate operating timing diagrams for a row of pixels of a pixel array where electromagnetic radiation from a sensor emitter is passing through the display. For example, FIGS. 4A and 4B may illustrate operating timing diagrams for the row 220 of the pixel array 212. The timing of the display system signals and of the electromagnetic sensor operation can be controlled by a controller, e.g., the controller 206 of the system 200.

FIG. 4A shows the timing diagram for a pixel row, e.g., the pixel row 220, without synchronization between the EM signal, the SCAN signal, and the electromagnetic sensor emitter. A first frame starts at time 404a and ends at time 414a for the pixel row 220. The frame time includes an emission-off period between time 404a and time 406a. During the emission-off period, none of the pixels in the row 220 emits light. Following the emission-off period, the pixel row 220 is programmed with an illumination level for each pixel in the frame. Though FIG. 4A is described here in reference to a single pixel, e.g., the pixel P11 of the row 220, the timing diagram of FIG. 4A illustrates the operation of all pixels in the row 220.

At time 404a, an EM signal pulse 403a starts, when the EM signal switches high. Referring back to FIG. 3, during the EM signal pulse 403a, the TFT T_{SW_E} switches off, blocking the current I_{OLED}. The luminance of the pixel drops to zero, turning the pixel off.

During the EM signal pulse 403a, the pixel receives a scan pulse 405a. The scan pulse 405a causes the pixel to scan the data voltage from data line D1 for the frame. The scan pulse 405a causes a temporary distortion 402a of gate voltage V_{G} and then overwrites the gate voltage V_{G} with new data for the frame before the pixel illuminates. At time 406a, the EM signal pulse 403a ends, or switches low. The TFT T_{SW_E} switches on, allowing the current I_{OLED} to flow to the OLED. The pixel luminance rises to the programmed level, e.g., the luminance that corresponds to the data voltage that was scanned during scan pulse 405a.

At time 408a, an emitter of an electromagnetic sensor begins emitting a pulse of electromagnetic radiation, e.g., an IR pulse 410a. The emitter can be, for example, the emitter 124 of the electromagnetic sensor 120 of the electronic device 100. While the emitter 124 emits the IR pulse 410a, the pixel circuit is exposed to the electromagnetic radiation of the IR pulse 410a. The leakage current I_{leakage} through the TFT T_{SW_1} rises, causing the gate voltage V_{G} to decrease. The lowering V_{G} causes the I_{OLED} to increase. Therefore, the pixel luminance increases. The pixel becomes brighter, resulting in a white dot appearing on the display. The electromagnetic sensor may affect multiple pixels within an area of the display that is exposed to the electromagnetic radiation.

At time 412a, the emitter 124 ceases the IR pulse 410a. The gate voltage V_{G} remains steady at a lower level than prior to the IR pulse 410a. The luminance remains steady at a higher level than prior to the IR pulse 410a. At time 414a, a next EM signal pulse 413a starts, beginning the next frame.

FIG. 4B shows the timing diagram for a pixel row, e.g., the pixel row 220, with synchronization between the EM signal, the SCAN signal, and the electromagnetic sensor emitter. A first frame starts at time 404b and ends at time 414b for the pixel row 220. The frame time includes an emission-off period between time 404b and time 408b. During the emission-off period, none of the pixels in the row 220 emits light. Following the emission-off period, the pixel row 220 is programmed with an illumination level for each pixel in the frame. Though FIG. 4B is described here in reference to a single pixel, e.g., the pixel P11 of the row 220, the timing diagram of FIG. 4B illustrates the operation of all pixels in the row 220.

At time 404b, an EM signal pulse 403b starts. During the EM signal pulse 403b, the TFT T_{SW_E} switches off, blocking the current I_{OLED}. The luminance of the pixel drops to zero, turning the pixel off.

Display system operation is synchronized such that during the EM signal pulse 403b, the emitter 124 of the electromagnetic sensor 120 begins emitting an IR pulse 410b. While the emitter 124 emits the IR pulse 410b, the pixel circuit is exposed to the electromagnetic radiation of the IR pulse 410b. The leakage current I_{leakage} through the TFT T_{SW_1} rises, causing the gate voltage V_{G} to decrease. Because the EM signal remains high, the TFT T_{SW_E} is off. Therefore, the current I_{OLED} remains zero, and the pixel remains unilluminated. Thus, by synchronizing the EM signal pulse 403b with the IR pulse 410b, visual artifacts, e.g., white dots, can be reduced.

At time 406b, the emitter 124 ceases the IR pulse 410b. The gate voltage V_{G} remains steady at a lower level than prior to the IR pulse 410b. However, the EM signal remains high, and the pixel remains unilluminated. Display system operation is synchronized such that during the EM signal pulse 403b, and after the end of the IR pulse 410b, the pixel receives a scan pulse 405b. The scan pulse 405b causes the pixel to scan the data voltage from data line D1 for the frame. The scan pulse 405b causes a temporary distortion 402b of gate voltage V_{G} and then overwrites the gate voltage V_{G} with new data for the frame before the pixel illuminates. The gate voltage V_{G}, previously lowered by the IR pulse 410b, rises to a programmed value associated with the new data.

At time 408b, the EM signal pulse 403b ends. The TFT T_{SW_E} switches on, allowing the current I_{OLED} to flow to the OLED. The pixel luminance rises to the programmed level, e.g., the luminance that corresponds to the data voltage that was scanned during scan pulse 405b. Thus, due to the synchronization between the IR pulse 410b and the EM signal pulse 403b, the electromagnetic radiation of the IR pulse 410b does not affect the luminance of the pixel. At time 414b, the next EM signal pulse 413b starts, beginning the next frame. During the next EM signal pulse 413b, the emitter 124 emits the next IR pulse 420b.

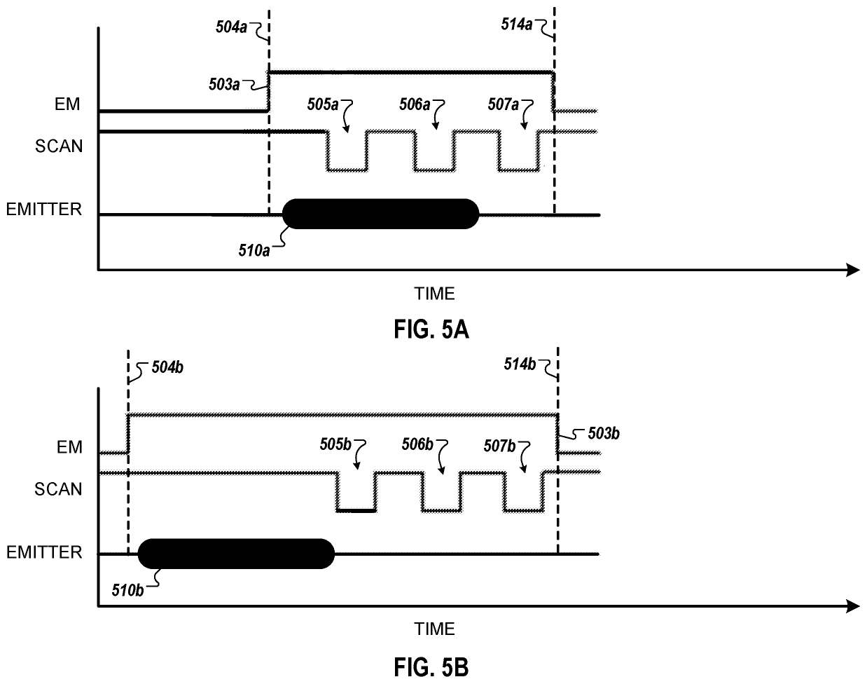

FIGS. 5A and 5B are example operating timing diagrams for displays that use more than one scan pulse per frame. FIGS. 5A and 5B illustrate operating timing diagrams for a row of pixels of a pixel array where electromagnetic radiation from a sensor emitter is passing through the display. For example, FIGS. 5A and 5B may illustrate operating timing diagrams for the row 220 of the pixel array 212. The timing of the display system signals and of the electromagnetic sensor operation can be controlled by a controller, e.g., the controller 206 of the system 200. Though FIGS. 5A and 5B are described here in reference to a single pixel, e.g., the pixel P11 of the row 220, the timing diagrams of FIGS. 5A and 5B illustrate the operation of all pixels in the row 220.

The timing diagram in FIG. 5A shows the timing diagram for a pixel, e.g., the pixel P11, with synchronization between the EM signal, the SCAN signal, and the electromagnetic sensor emitter. In the example of FIG. 5A, one or more of the scan pulses occurs during an IR pulse.

At time 504a, an EM signal pulse 503a starts, beginning an emission-off period of a frame. Display system operation is synchronized such that during the EM signal pulse 503a, the emitter 124 of the electromagnetic sensor 120 begins emitting an IR pulse 510a. While the emitter 124 emits the IR pulse 510a, the pixel circuit is exposed to the electromagnetic radiation of the IR pulse 510a. The leakage current I_{leakage} through the TFT T_{SW_1} rises, causing the gate voltage V_{G} to decrease. Because the EM signal remains high, the TFT T_{SW_E} is off. Therefore, the current I_{OLED} remains zero, and the pixel remains unilluminated. Thus, by synchronizing the EM signal pulse 503a with the IR pulse, visual artifacts, e.g., white dots, can be reduced.

The timing diagram in FIG. 5A includes more than one scan pulse during the emission-off period. For example, the timing diagram in FIG. 5A includes three scan pulses 505a, 506a, 507a, during the emission-off period between time 504a and time 514a. The scan pulses 505a and 506a can be used for precharging and initializing the pixel circuits. During the precharging scan pulses, the row of pixels receives a precharging voltage. Precharging scan pulses can improve the appearance and clarity of motion shown on the display. The precharging scan pulses 505a and 506a may occur during the IR pulse 510a.

The scan pulse 507a is the final scan pulse before the pixel illuminates. The scan pulse 507a is used for scanning image data for the frame. Display system operation is synchronized such that the IR pulse 510a may occur during the precharging scan pulses 505a and 506a, but the IR pulse 510 does not occur during the scan pulse 507a. Thus, due to synchronization, the pixel receives the scan pulse 507a during the EM signal pulse 503a and after the end of the IR pulse 510a. The scan pulse 507a causes the pixel to scan the data voltage for the frame. The scan pulse 507a overwrites the gate voltage V_{G} with new data for the next frame before the pixel illuminates.

At time 514a, the EM signal pulse 503a ends. The TFT T_{SW_E} switches on, allowing the current I_{OLED} to flow to the OLED. The pixel luminance rises to the programmed level, e.g., the luminance that corresponds to the data voltage that was scanned during scan pulse 507a. Thus, due to the synchronization between the IR pulse 510a, the EM signal pulse 503a, and the SCAN signal, the electromagnetic radiation of the IR pulse 510a does not affect the luminance of the pixel.

The timing diagram in FIG. 5B shows the timing diagram for a pixel, e.g., the pixel P11, with synchronization between the EM signal, the SCAN signal, and the electromagnetic sensor emitter. In the example of FIG. 5B, none of the scan periods occur during an IR pulse.

At time 504b, an EM signal pulse 503b starts. During the EM signal pulse 503b, the TFT T_{SW_E} switches off, blocking the current I_{OLED}. The luminance of the pixel drops to zero, turning the pixel off. Display system operation is synchronized such that during the EM signal pulse 503b, the emitter 124 of the electromagnetic sensor 120 begins emitting an IR pulse 510b. While the emitter 124 emits the IR pulse 510b, the pixel circuit is exposed to the electromagnetic radiation of the IR pulse 510b. The leakage current I_{leakage} through the TFT T_{SW_1} rises, causing the gate voltage V_{G} to decrease. Because the EM signal remains high, the TFT T_{SW_E} is off. Therefore, the current I_{OLED} remains zero, and the pixel remains unilluminated. Thus, by synchronizing the EM signal pulse 503b with the IR pulse, visual artifacts, e.g., white dots, can be reduced.

The timing diagram in FIG. 5B includes more than one scan pulse, or scan period, during the emission-off period. For example, the timing diagram in FIG. 5B includes three scan pulses 505b, 506b, 507b, during the emission-off period between time 504a and time 514a. The scan pulses 505b and 506b are used for precharging and initializing the pixel circuits. Precharging scan pulses can improve the appearance and clarity of motion shown on the display. The scan pulse 507b is the final scan pulse before the beginning of the next frame. The scan pulse 507b is used for scanning image data for the next frame.

The precharging scan pulses 505b and 506b, and the final scan pulse 507b, can each occur after the end of the IR pulse 510b. Display system operation is synchronized such that during the EM signal pulse 503b, and after the end of the IR pulse 510b, the pixel receives the scan pulses 505b, 506b, and 507b. The scan pulse 507b causes the pixel to scan the data voltage from data line D1 for the frame. The scan pulse 507b overwrites the gate voltage V_{G} with new data for the frame before the pixel illuminates.

At time 514b, the EM signal pulse 503b ends. The TFT T_{SW_E} switches on, allowing the current I_{OLED} to flow to the OLED. The pixel luminance rises to the programmed level, e.g., the luminance that corresponds to the data voltage that was scanned during scan pulse 507b. Thus, due to the synchronization between the IR pulse 510b, the EM signal pulse 503b, and the SCAN signal, the electromagnetic radiation of the IR pulse 510b does not affect the luminance of the pixel.

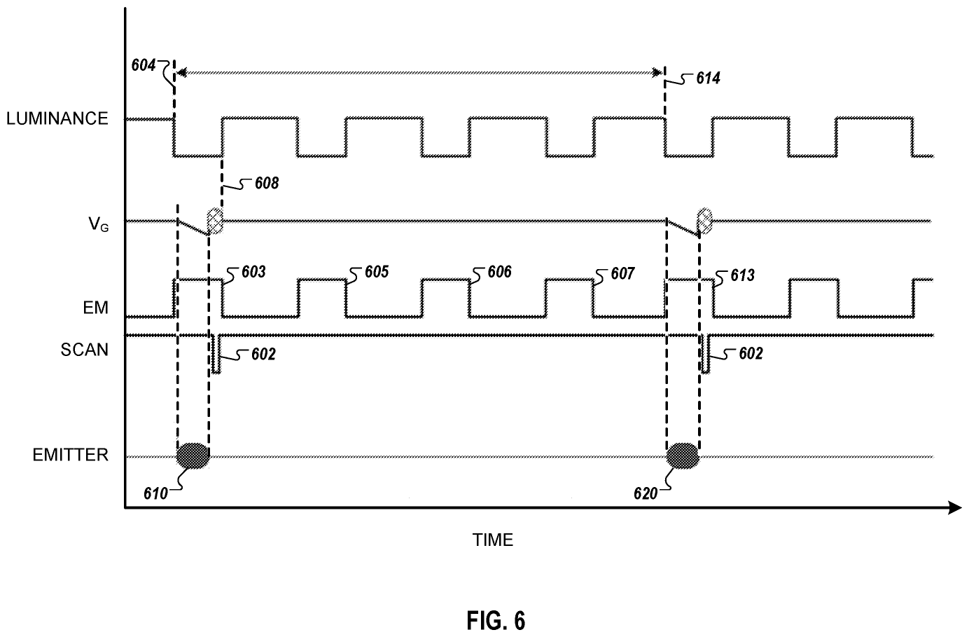

FIG. 6 is an example operating timing diagram for displays that use more than one EM signal pulse per frame. FIG. 6 illustrates an operating timing diagram for a row of pixels of a pixel array where electromagnetic radiation from a sensor emitter is passing through the display. For example, FIG. 6 may illustrate an operating timing diagram for the row 220 of the pixel array 212. The timing of the display system signals and of the electromagnetic sensor operation can be controlled by a controller, e.g., the controller 206 of the system 200. FIG. 6 shows the timing diagram for a pixel, e.g., the pixel P11, with synchronization between the EM signal, the SCAN signal, and the electromagnetic sensor emitter.

A first frame starts at time 604 and ends at time 614 for the pixel row 220. The frame time includes a first emission-off period between time 604 and time 608, during the EM signal pulse 603. The frame time includes additional emission-off periods during additional EM signal pulses 605, 606, and 607. During the emission-off periods, none of the pixels in the row 220 emits light. Following each of the emission-off periods, the pixel row 220 illuminates at a programmed illumination level for each pixel in the frame. Though FIG. 6 is described here in reference to a single pixel, e.g., the pixel P11 of the row 220, the timing diagram of FIG. 6 illustrates the operation of all pixels in the row 220.

At time 604, the EM signal pulse 603 starts. During the EM signal pulse 603, the TFT T_{SW_E} switches off, blocking the current I_{OLED}. The luminance of the pixel drops to zero, turning the pixel off. The EM signal pulse 603 is the first EM signal pulse of the frame. During the first EM signal pulse 603 of the frame, the pixel receives a scan pulse 602.

Display system operation is synchronized such that the emitter 124 emits the IR pulse during the EM signal pulse during which the pixel receives the scan pulse 602. In the example of FIG. 6, the pixel receives the scan pulse 602 during the first EM signal pulse 603 of the EM signal pulses 603, 605, 606, and 607. In some examples, the pixel may receive the scan pulse 602 during an EM signal pulse other than the first EM signal pulse. For example, the pixel may receive the scan pulse during the second EM signal pulse 605, the third EM signal pulse 606, etc. Display system operation is synchronized such that the emitter 124 emits the IR pulse during the EM signal pulse that corresponds with the scan pulse 602.

During the first EM signal pulse 603, and before the pixel receives the scan pulse 602, the emitter 124 of the electromagnetic sensor 120 begins emitting an IR pulse 610. While the emitter 124 emits the IR pulse 610, the pixel circuit is exposed to the electromagnetic radiation of the IR pulse 610. The leakage current I_{leakage} through the TFT T_{SW_1} rises, causing the gate voltage V_{G} to decrease. Because the EM signal pulse 603 remains high, the TFT T_{SW_E} is off. Therefore, the current I_{OLED} remains zero, and the pixel remains unilluminated. Thus, by synchronizing the EM signal pulse 603 with the IR pulse 610, visual artifacts, e.g., white dots, can be reduced.

Display system operation is synchronized such that during the EM signal pulse 603, and after the end of the IR pulse 610, the pixel receives the scan pulse 602. The scan pulse 602 causes the pixel to scan the data voltage from data line D1 for the frame. The scan pulse 602 overwrites the gate voltage V_{G} with new data for the frame before the pixel illuminates.

At time 608, the EM signal pulse 603 ends. The TFT T_{SW_E} switches on, allowing the current I_{OLED} to flow to the OLED. The pixel luminance rises to the programmed level, e.g., the luminance that corresponds to the data voltage that was scanned during scan pulse 602.

The EM signal pulses 605, 606, and 607 each occur during the frame time between time 604 and time 614. The EM signal pulses 605, 606, and 607 each occur after the IR pulse 610, and after the scan pulse 602. Because no scan pulses occur during the EM signal pulses 605, 606, and 607, no new image data is emitted by the pixel. Following each of the EM signal pulses 605, 606, and 607, the pixel luminance rises to the programmed level. Thus, due to the synchronization between the IR pulse 610, the EM signal pulses 603, 605, 606, 607, and the scan pulse 602, the electromagnetic radiation of the IR pulse 610 does not affect the luminance of the pixel.

At time 614, the EM signal pulse 613 starts, beginning a next frame. The electromagnetic sensor emits an IR pulse 620 during a next EM signal pulse 613, and before the pixel receives a next scan pulse 612 with new image data for the next frame.

The processes described above for reducing visual artifacts due to electromagnetic radiation can be applied to one or more groups of pixels of a display. For example, the processes can be applied to one or more pixel rows or pixel columns of a pixel array. That is, a pixel row or a pixel column are examples of different groups of pixels. In some examples, a display system can synchronize IR pulses with EM signals and SCAN signals for only the pixel rows that are located over an emitter. For example, a controller may synchronize IR pulses with EM signals and SCAN signals for the one or more pixel rows that are located in closest proximity to the emitter. Conversely, a display system may not synchronize IR pulses with EM signals and SCAN signals for the pixel rows that are not located over an emitter. For example, a controller may synchronize IR pulses with EM signals and SCAN signals for the one or more pixel rows that are located in closest proximity to the emitter, but not for the one or more pixel rows that are located further away from the emitter. In this way, different areas of a display may be driven in different ways.

Embodiments of the subject matter and the functional operations described in this specification can be implemented in any suitable electronic device such as a personal computer, a mobile telephone, a smart phone, a smart watch, a smart TV, a mobile audio or video player, a game console, or a combination of one or more of these devices.

The electronic device may include various components such as a memory, a processor, a display, and input/output units. The input/output units may include, for example, a transceiver that can communicate with the one or more networks to send and receive data. The display may be any suitable display including, for example, a cathode ray tube (CRT), liquid crystal display (LCD), or light emitting diode (LED) display, for displaying images.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Embodiments may be implemented as one or more computer program products, e.g., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both.

Elements of a computer may include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer may not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of driving a display comprising a plurality of groups of light-emitting pixels, wherein a sensor is arranged under the display, the sensor comprising an emitter arranged to direct electromagnetic radiation through multiple pixels of the display located over the emitter during operation, the method comprising:
addressing each group of pixels in the plurality of groups of light-emitting pixels with one or more signals according to a frame rate, wherein a period of each frame during which the groups of light-emitting pixels are addressed comprises an emission-off period during which none of the multiple pixels located over the emitter emit light; and
synchronizing emission of electromagnetic radiation from the emitter through the multiple pixels located over the emitter to occur during the emission-off period of the multiple pixels located over the emitter.

2. The method of claim 1, wherein the period of each frame comprises a scan period during which the pixels in each group of pixels receive a data signal, the method further comprising:
synchronizing emission of electromagnetic radiation from the emitter through the multiple pixels of the display located over the emitter to occur before the scan period.

3. The method of claim 1, wherein the period of each frame comprises:
a plurality of emission-off periods; and
a scan period during which the pixels in each group of pixels receive a data signal, the scan period occurring during one of the plurality of emission-off periods, the method further comprising:
synchronizing emission of electromagnetic radiation from the emitter through the multiple pixels of the display located over the emitter to occur during the one period of the plurality of emission-off periods during which the scan period occurs.

4. The method of claim 1, wherein the period of each frame comprises:
a plurality of scan periods occurring during the emission-off period, the plurality of scan periods comprising:
at least one scan period during which the multiple pixels located over the emitter receive a precharging voltage; and
a scan period during which the multiple pixels located over the emitter receive a data signal,
the method further comprising synchronizing emission of electromagnetic radiation from the emitter through the multiple pixels of the display located over the emitter to occur (i) during the emission-off period and (ii) before the scan period during which the multiple pixels located over the emitter receive the data signal.

5. The method of claim 4, wherein the scan period during which the multiple pixels located over the emitter receive the data signal comprises a final scan period of the plurality of scan periods.

6. The method of claim 1, wherein the emission-off period occurs prior to programming an illumination level for each pixel in the corresponding frame.

7. The method of claim 1, wherein each group of pixels comprises a row of pixels or a column of pixels.

8. The method of claim 1, comprising repeatedly synchronizing emission of electromagnetic radiation from the emitter through the multiple pixels of the display located over the emitter to occur during emission-off periods of additional frames.

9. The method of claim 1, wherein synchronizing the emission of electromagnetic radiation from the emitter through the multiple pixels located over the emitter to occur during the emission-off period comprises:
starting the emission of electromagnetic radiation from the emitter at or after the start of the emission-off period; and
stopping the emission of electromagnetic radiation from the emitter at or before the end of the emission-off period.

10. The method of claim 1, wherein the electromagnetic radiation is one of infrared radiation, ultraviolet radiation, or radio wave radiation.

11. The method of claim 1, wherein each light emitting pixel of the groups of light-emitting pixels in the plurality of groups of light-emitting pixels comprises an organic light-emitting diode.

12. A system comprising:
a display comprising a plurality of groups of light-emitting pixels;
a sensor arranged under the display, the sensor comprising an emitter arranged to direct electromagnetic radiation through multiple pixels of the display located over the emitter during operation; and
a controller configured to perform operations comprising:
addressing each group of pixels in the plurality of groups of light-emitting pixels with one or more signals according to a frame rate, wherein a period of each frame during which the groups of light-emitting pixels are addressed comprises an emission-off period during which none of the multiple pixels located over the emitter emit light; and
synchronizing emission of electromagnetic radiation from the emitter through the multiple pixels located over the emitter to occur during the emission-off period of the multiple pixels located over the emitter.

13. The system of claim 12, wherein the period of each frame comprises a scan period during which the pixels in each group of pixels receive a data signal, the operations further comprising:
synchronizing emission of electromagnetic radiation from the emitter through the multiple pixels of the display located over the emitter to occur before the scan period.

14. The system of claim 12, wherein the period of each frame comprises:
a plurality of emission-off periods; and
a scan period during which the pixels in each group of pixels receive a data signal, the scan period occurring during one of the plurality of emission-off periods, the operations further comprising:
synchronizing emission of electromagnetic radiation from the emitter through the multiple pixels of the display located over the emitter to occur during the one period of the plurality of emission-off periods during which the scan period occurs.

15. The system of claim 12, wherein the period of each frame comprises:
a plurality of scan periods occurring during the emission-off period, the plurality of scan periods comprising:
at least one scan period during which the multiple pixels located over the emitter receive a precharging voltage; and
a scan period during which the multiple pixels located over the emitter receive a data signal,
the operations further comprising synchronizing emission of electromagnetic radiation from the emitter through the multiple pixels of the display located over the emitter to occur (i) during the emission-off period and (ii) before the scan period during which the multiple pixels located over the emitter receive the data signal.

16. The system of claim 15, wherein the scan period during which the multiple pixels located over the emitter receive the data signal comprises a final scan period of the plurality of scan periods.

17. The system of claim 12, wherein the emission-off period occurs prior to programming an illumination level for each pixel in the corresponding frame.

18. The system of claim 12, wherein each group of pixels comprises a row of pixels or a column of pixels.

19. The system of claim 12, wherein the operations comprise repeatedly synchronizing emission of electromagnetic radiation from the emitter through the multiple pixels of the display located over the emitter to occur during emission-off periods of additional frames.

20. The system of claim 12, wherein synchronizing the emission of electromagnetic radiation from the emitter through the multiple pixels located over the emitter to occur during the emission-off period comprises:
starting the emission of electromagnetic radiation from the emitter at or after the start of the emission-off period; and
stopping the emission of electromagnetic radiation from the emitter at or before the end of the emission-off period.
